(19) United States
(12) Patent Application Publication
(10) Pub. No.: US 2009/0237366 A1
(43) Pub. Date: Sep. 24, 2009

(54) Multi-Touch Points Sensible Touch Panel and Method for controlling the same

(76) Inventors: Shang - Tai Yeh, Taipei (TW); Shih-Chieh Hsu, Taipei (TW)

Correspondence Address: KAMRATH & ASSOCIATES P.A., 4825 OLSON MEMORIAL HIGHWAY, SUITE 245, GOLDEN VALLEY, MN, 55422, US

(21) Appl. No.: 12/135,263

(22) Filed: Jun. 9, 2008

(30) Foreign Application Priority Data
Mar. 21, 2008 (TW) 097109968

(51) Int. Cl. G06F 3/041

(52) U.S. Cl. 345/173

(57) ABSTRACT

A multi-contact points sensible touch panel has a substrate module, multiple infrared (IR) transmitter and multiple IR receivers to provide IR signal being transmitted along different directions. The first transmission direction is orthogonal to the second transmission direction. The third transmission direction intersects the first transmission direction with a first nonzero oblique angle, and also intersects the second transmission direction with a second nonzero oblique angle. When multiple contact points occur on the touch panel, coordinate of each contact points is correctly determined by sensing a position where the IR signals of different directions intersect together.

### BACKGROUND OF THE INVENTION

1. Field of the Invention

The present invention relates to a touch panel device and its control method, and more particularly to a touch panel and a method capable of simultaneously sensing coordinates of multiple touch points.

2. Description of Related Art

Touch panel is a widely used interface for most electronic devices. There are a number of types of touch panel, such as resistive, captive or infrared types.

With reference to FIG. 8, an infrared (IR) touch panel in accordance with prior art comprises a rectangular substrate (80) with two opposite long edges and two opposite short edges, multiple IR transmitters (81)(83) and multiple IR receivers (82)(84). The IR transmitters (81)(83) are mounted along one long edge and one short edge of the substrate (80). The IR receivers (82)(84) are mounted along the other long edge and the other short edge of the substrate (80). The IR transmitters (81) along the long edge respectively correspond to the IR receivers (82) of the opposite long edge. The IR transmitters (83) along the short edge respectively correspond to the IR receivers (84) of the opposite short edge. The IR transmitters (81)(83) are sequentially activated to emit IR signals and the IR receivers (82)(84) are also correspondingly turned on to sense the emitted IR signals. A region encompassed by the IR signals is defined as an active area (AA).

With further reference to FIG. 9, when a user touches on a contact point within the active area with his finger or a pen, the IR signals from the two IR transmitters (81)(83) respectively near the long edge and the short edge are interrupted. Two receivers (82)(84) corresponding to the two IR transmitters (81)(83) accordingly receive no signals. The coordinate of the contact point can be calculated by determining whether the IR transmitters (81)(83) receive signals.

However, the foregoing IR touch panel correctly locates the contact point only when there is only one contact point. If more than one of the contact points occur on the touch panel simultaneously, the touch panel may incorrectly determine their positions.

With reference to FIG. 10, there are two contact points a, b within the active area. In theory, both the contact points a, b are recognizable when the two IR receivers (82′, 84′) receivers and the other two IR receivers (82″, 84″) do not receive any IR signals. However, without receptions of the IR signals by the four IR receivers (82′)(84′)(82″)(84″), the touch panel determines that there are four contact points a, b, a′ and b′. Since the positions of a′ and b′ also correspond to the IR receivers (82′, 84″) and (82″, 84″), the touch panel deems the two positions as the contact points. The drawback limits the applications of the IR touch panel.

To overcome the shortcomings that the touch panel cannot correctly recognize more than one contact point, the present invention provides a multi-contact points sensible touch panel and a method for controlling the same to mitigate or obviate the aforementioned problems.

### SUMMARY OF THE INVENTION

The main objective of the present invention is to provide a multi-contact points sensible touch panel that simultaneously and correctly determines coordinates of multiple contact points.

To achieve the objective, the touch panel uses a substrate module, multiple infrared (IR) transmitter and multiple IR receivers mounted on the substrate module to generate IR signals being transmitted along different directions. The first transmission direction is orthogonal to the second transmission direction. The third transmission direction intersects the first transmission direction with a first nonzero oblique angle, and also intersects the second transmission direction with a second nonzero oblique angle.

When multiple contact points occur on the touch panel, coordinate of each contact points is correctly determined by sensing a position where the IR signals of different directions intersect together.

Another objective of the present invention is to provide a control method for the touch panel, the method comprising the acts of:

providing a first IR signal transmitted over the multi-contact points sensible touch panel and along a first transmission direction;

providing a second IR signal transmitted over the multi-contact points sensible touch panel and along a second transmission direction orthogonal to the first transmission direction;

providing a third IR signal transmitted over the multi-contact points sensible touch panel and along a third transmission direction different from the first transmission direction and the second transmission direction; and

determining a coordinate of a contact point where the first IR signal, the second IR signal and the third IR signal intersecting each other.

Other objectives, advantages and novel features of the invention will become more apparent from the following detailed description when taken in conjunction with the accompanying drawings.

### BRIEF DESCRIPTION OF THE DRAWINGS

FIG. 1 is a schematic view of a multi-contact points sensible touch panel in;

FIG. 2 is a schematic view of the multi-contact points sensible touch panel determining two contact points in accordance with the present invention;

FIG. 3 is an exploded perspective view of the multi-contact points sensible touch panel in accordance with the present invention;

FIG. 4 is a schematic view of a first embodiment of the multi-contact points sensible touch panel in accordance with the present invention;

FIG. 5 is a schematic view of a second embodiment of the multi-contact points sensible touch panel in accordance with the present invention;

FIG. 6 is a schematic view of a third embodiment of the multi-contact points sensible touch panel in accordance with the present invention;

FIG. 7 is a schematic view of the third embodiment of the multi-contact points sensible touch panel in accordance with the present invention;

FIG. 8 is a schematic view of a conventional IR touch panel in accordance with prior art;

FIG. 9 is an operational view of the IR touch panel determining the coordinate of a contact point in accordance with prior art; and

FIG. 10 is an operational view of the IR touch panel determining more than one contact point in accordance with prior art.

### DETAILED DESCRIPTION OF THE PREFERRED EMBODIMENT

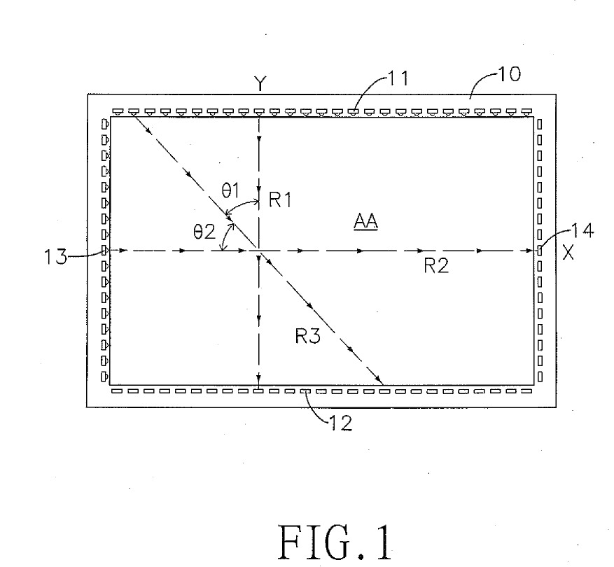

With reference to FIG. 1, a multi-contact points sensible touch panel in accordance with the present invention comprises a substrate module (10), multiple first infrared (IR) transmitters (11), second IR transmitters (13), first IR receivers (12) and second IR receivers (14).

The substrate module (10) is rectangular and has two opposite long edges and two opposite short edges. The substrate module (10) may be a single substrate or consisted of a top substrate (101) and a bottom substrate (102).

The first and second IR transmitters (11)(13) are mounted along one long edge and one short edge of the substrate module (10) respectively to provide first IR signals and second IR signals.

The first and second IR receivers (12)(14) are mounted along the other long edge and the other short edge of the substrate module (10) respectively, and correspond to the first and second IR transmitters (11)(13) one by one.

The first IR transmitters (11) and the first IR receivers (12) respectively adjacent to the opposite long edges of the substrate module (10) allow the first IR signals being transmitted along a first transmission direction R1 parallel to a Y axis of the substrate module (10).

The second IR transmitters (13) and the second IR receivers (14) adjacent to the opposite short edges of the substrate module (10) allow the second IR signals being transmitted along a second transmission direction R2 parallel to an X axis of the substrate module (10). The second transmission direction R2 is orthogonal to the first transmission direction R1.

In addition to the two transmission directions R1 R2, a third transmission direction R3 for third IR signals is provided on the substrate module (10). The third signal transmission direction R3 intersects the first transmission direction R1 with a first nonzero oblique angle θ1 and intersects the second transmission direction R2 with a second nonzero oblique angle θ2. As an example, both the first angle θ1 and the second angle θ1 are 45 degrees.

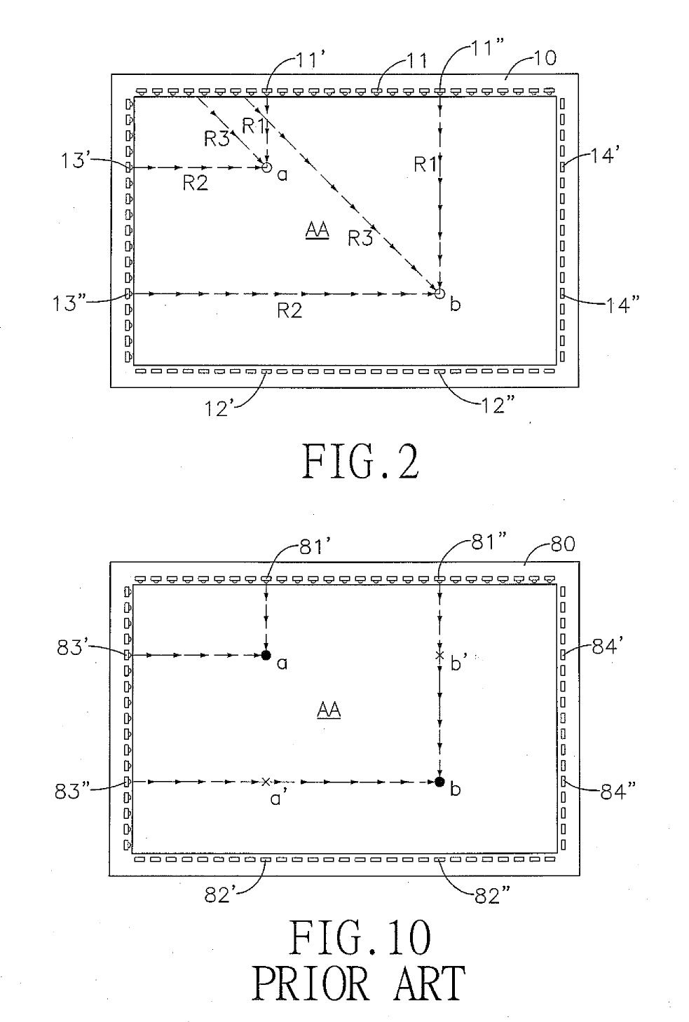

With reference to FIG. 2, because IR signals between the transmitters and receivers are transmitted along three different directions R1, R2 and R3, any contact point where the IR signals along different directions R1, R2 and R3 intersect together can be accurately located. Therefore, even though multiple contact points occur at the same time, coordinates of the multiple contact points can be determined respectively without any error. The IR signals transmitted along the three directions R1, R2 and R3 encompass a region. The region is defined as an active area (AA) of the substrate module (10). When two contact points a and b simultaneously occur on the substrate module (10), each contact point of a and b is a point where the three IR signals of different directions intersect together. For example, the contact point a blocks the IR signals along the directions R1 to R3 from a first IR transmitter (11′), a second IR transmitter (13′) and a third IR transmitter (not show), and causes a corresponding first IR receiver (12′), a second IR receiver (14′) and a third receiver (not shown) to have no signal reception.

Similarly, the contact point b blocks the IR signals along the directions R1 to R3 from a first IR transmitter (11″), a second IR transmitter (13″) and a third IR transmitter (not show), and causes a corresponding first IR receiver (12″), a second IR receiver (14″) and a third receiver (not shown) to have no signal reception.

According to the present invention, even though other contact points a′ or b′ as shown in FIG. 10 occur on the touch panel, coordinates of the contact points a and a′ or contact points b and b′ still can correctly determined. In more detail, since contact points a and a′ will not interfere the same third IR signal transmitted along the third transmission direction R3, the contact a and a′ are distinct from each other.

With regard to the third IR signals along the third transmission direction R3, the third IR signals may be either emitted by additional IR transmitters and received by additional IR receivers, or by the original transmitters (11)(13) and receivers (12)(14).

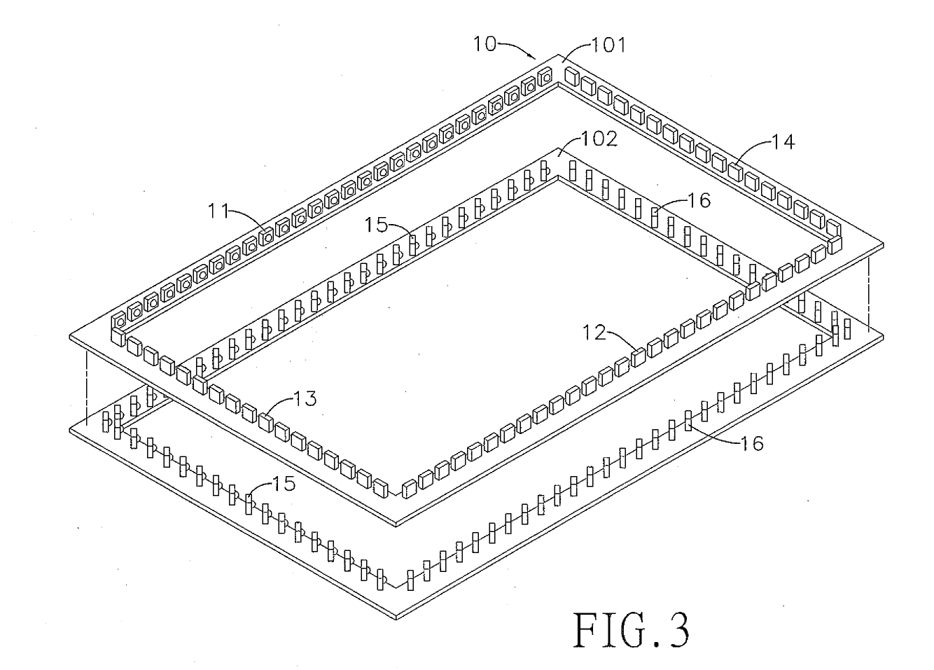

With reference to FIG. 3, the substrate module (10) comprises a top substrate (101) and a bottom substrate (102). The first infrared (IR) transmitters (11) and the first IR receivers (12) are mounted along the opposite long edges of the top substrate (101). The second infrared (IR) transmitters (13) and the second IR receivers (14) are mounted along the opposite short edges of the top substrate (101). The bottom substrate (102) has multiple third IR transmitters (15) and third IR receivers (16) for transmissions of the third IR signals.

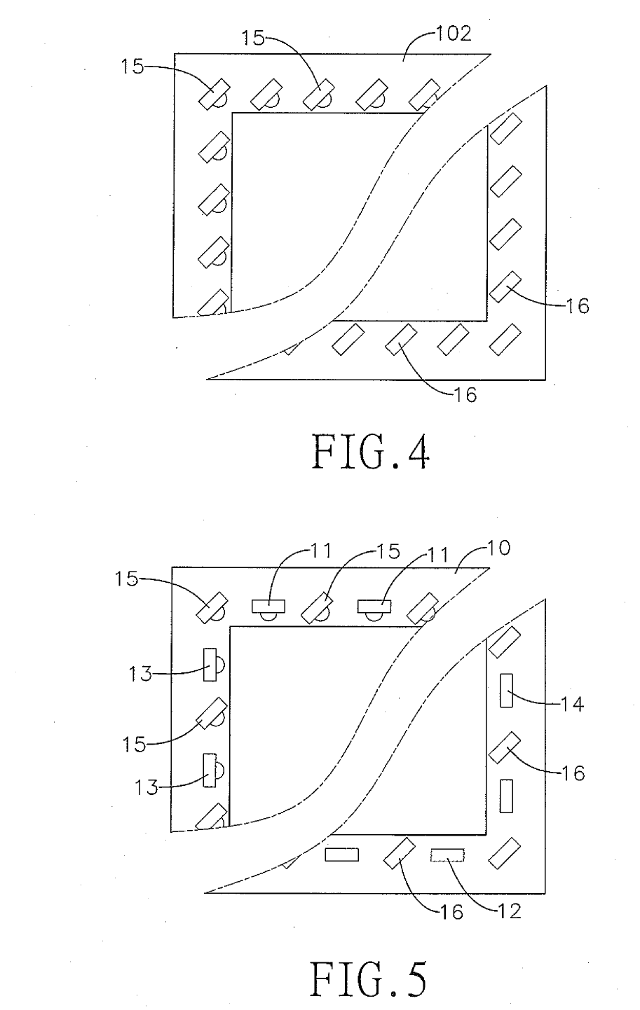

With further reference to FIG. 4, the third IR transmitters (15) are mounted along and inclined relative to one long edge and one short edge of the bottom substrate (102) to transmit the third IR signals. The third IR receivers (16) are mounted along and inclined relative to the other long edge and the other short edge of the bottom substrate (102) to respectively correspond to the third IR transmitters (155) and diagonally receive the third IR signals.

With further reference to FIG. 5, the substrate module (10) is a single substrate on which the first, second and third IR transmitters (11)(13)(15) together with the first, second and third IR receivers (12)(14)(16) are all mounted along the long edges or the short edges. Each of the third IR transmitters (15) is mounted either between two adjacent first IR transmitter (11) or between two adjacent second IR transmitter (13), and is inclined relative to the long edges or the short edges of the substrate module (10). Each of the third IR receivers (16) is mounted either between two adjacent first IR receivers (12) or between two adjacent second IR receivers (14), and is inclined relative to the long edges or the short edges of the substrate module (10).

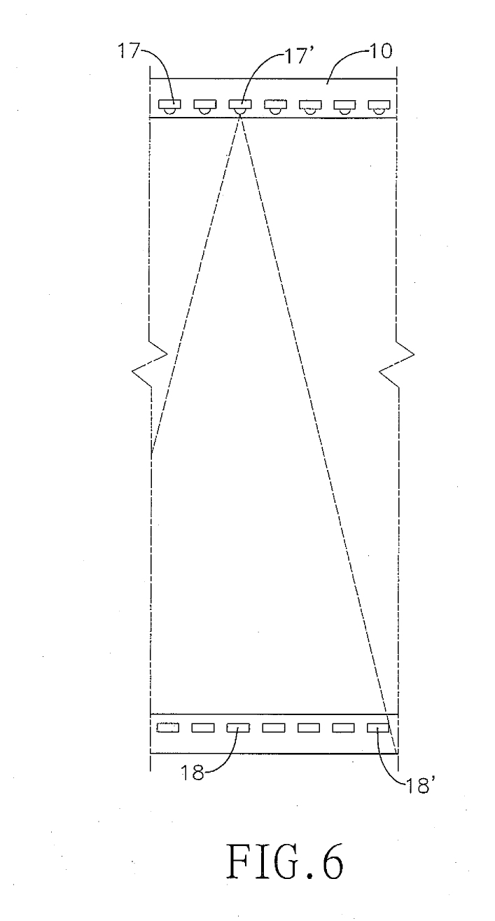

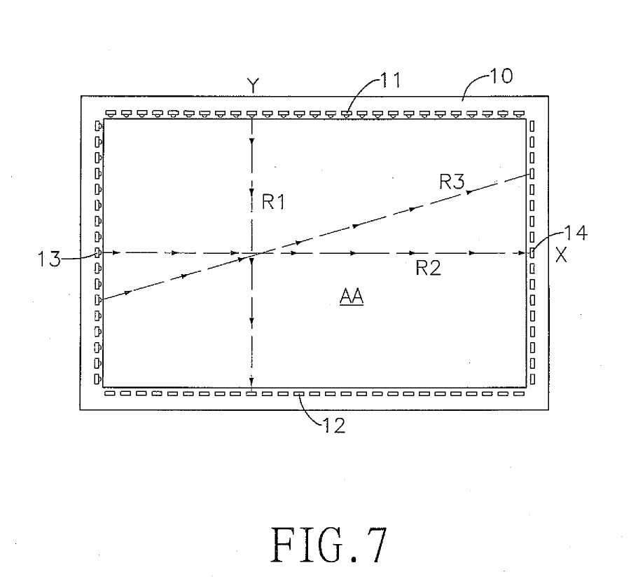

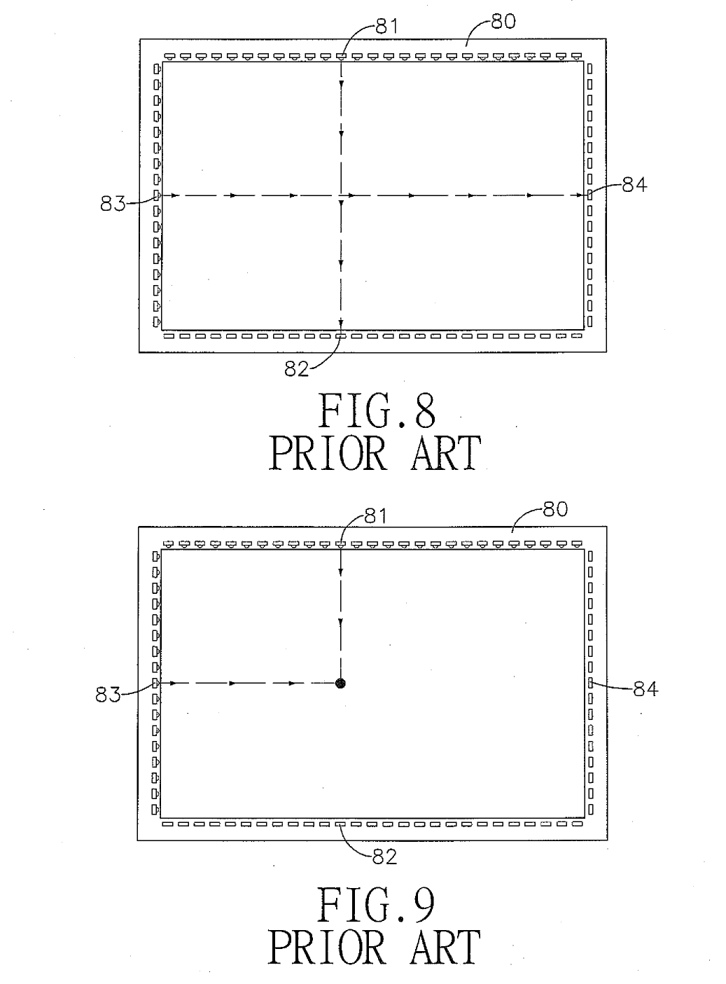

With further reference to FIGS. 6 and 7, the substrate module (10) uses multiple IR transmitters (17)(17′) and multiple IR receivers (18)(18′) as the foregoing first and second IR transmitters (11)(13) and the first and second IR receivers (12)(14). The multiple IR transmitters (17)(17′) and multiple IR receivers (18)(18′) are driven sequentially in pairs to provide the first IR signals along the first transmission direction R1 or the second IR signals along the second transmission direction R2. For example, a most left IR transmitter (17) and a most left IR receiver (18) mounted respectively along the opposite long edges of the substrate module (10) are driven simultaneously to emit and receive IR signals. A next IR transmitter (17) and a next IR receiver (18) adjacent to the previously-driven IR transmitter and receiver are subsequently activated.

Furthermore, since the IR signal transmission area of each IR transmitter (17) is substantially fan-shaped, other IR receivers (18) that are diagonally opposite to the IR transmitter (17) have capability to receive the emitted IR signal. For instance, when the IR transmitter (17′) on FIG. 6 transmits an IR signal, the IR receiver (18′) is activated to sense the emitted IR signal from the transmitter (17′). Therefore, the transmitter (17′) and receiver (18′) also achieve the third IR signal transmission along the third transmission direction R3. That is, each first IR signal is emitted over the IR signal transmission area with a divergence angle and can be received by two first IR receivers (12) within the IR signal transmission area. Similarly, the second IR signal is emitted over the IR signal transmission area with a divergence angle and can be received by two second IR receivers (14) within the IR signal transmission area.

Accordingly, the present invention provides a multi-contact points sensible touch panel, comprising multiple first IR transmitters (11), multiple first IR receivers (12), multiple second IR transmitters (13), and multiple second IR transmitters (14). Each of at least one first IR transmitter (11) emits a first IR signal respectively received by one of the first IR receivers (12) along a first transmission direction. Furthermore, each of at least one second IR transmitter (13) respectively emits a second IR signal over a fan-shaped signal transmission area with two of the second IR receivers (14) that receive the second IR signal along a second transmission direction and a third transmission direction. The second transmission direction is orthogonal to the first transmission direction, and the third transmission direction intersects the first transmission direction with a first nonzero angle and the second transmission direction with a second nonzero angle.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A multi-contact points sensible touch panel comprising:
a substrate module;
first IR signals transmitted over the substrate module along a first transmission direction;
second IR signals transmitted over the substrate module along a second transmission direction orthogonal to the first transmission direction;
third IR signals transmitted over the substrate module along a third transmission direction intersecting the first transmission direction with a first nonzero angle, and intersecting the second transmission direction with a second nonzero angle.

2. The touch panel as claimed in claim 1, wherein
the substrate module has two opposite long edges and two opposite short edges;
the first IR signals are transmitted between multiple first IR transmitters mounted along one long edge and multiple first IR receivers mounted along the other long edge of the substrate module; and
the second IR signals are transmitted between multiple second IR transmitters mounted along one short edge and multiple second IR receivers mounted along the other short edge of the substrate module.

3. The touch panel as claimed in claim 2, wherein
the substrate module comprises a top substrate and a bottom substrate;
the first IR transmitters, the first IR receivers, the second IR transmitters and the second IR receivers are mounted on the top substrate; and
the bottom substrate has two opposite long edges and two opposite short edges and comprises
multiple third IR transmitters mounted along and being inclined relative to one long edge and one short edge of the bottom substrate, and transmitting the third IR signals; and
multiple third IR receivers mounted along and being inclined relative to the other long edge and the other short edge of the bottom substrate to respectively correspond to the third IR transmitters, and receiving the third IR signals.

4. The touch panel as claimed in claim 2, wherein the third IR signals are transmitted between multiple third IR transmitters edge and multiple third IR receivers;
each of the third IR transmitters is mounted either between two adjacent first IR transmitters or between two adjacent second IR transmitters, and is inclined relative to the long edge and the short edge of the substrate module; and
each of the third IR receivers is mounted either between two adjacent first IR receivers or between two adjacent second IR receivers, and is inclined relative to the long edge and the short edge of the substrate module.

5. The touch panel as claimed in claim 2, wherein each of the first IR transmitters and each of the second IR transmitters has a fan-shaped signal transmission area and is controllable to emit the third IR signals; and
each of the first IR receivers and each of the second IR receivers is within the fan-shaped signal transmission area and is controllable to diagonally receive the third IR signals.

6. A control method for a multi-contact points sensible touch panel comprising the acts of:
providing a first IR signal transmitted over the multi-contact points sensible touch panel and along a first transmission direction;
providing a second IR signal transmitted over the multi-contact points sensible touch panel and along a second transmission direction orthogonal to the first transmission direction;
providing a third IR signal transmitted over the multi-contact points sensible touch panel and along a third transmission direction different from the first transmission direction and the second transmission direction; and
determining a coordinate of a contact point where the first IR signal, the second IR signal and the third IR signal intersecting each other.

7. The method as claimed in claim 6, wherein the first transmission direction is parallel to an X-axis of the multi-contact points sensible touch panel, the second direction is parallel to an Y-axis of the multi-contact points sensible touch panel, and the third transmission direction intersects the first transmission direction with a first nonzero angle and intersects the second transmission direction with a second nonzero angle.

8. The method as claimed in claim 7, wherein the first nonzero angle and the second nonzero angle are 45 degrees.

9. A multi-contact points sensible touch panel comprising:
a plurality of first IR transmitters and first IR receivers, wherein each of at least one first IR transmitter emits a first IR signal respectively received by one of the first IR receivers along a first transmission direction; and
a plurality of second IR transmitters and second IR receivers wherein each of at least one second IR transmitter respectively emits a second IR signal over a fan-shaped signal transmission area with two of the second IR receivers receive the second IR signal along a second transmission direction and a third transmission direction;
wherein the second transmission direction is orthogonal to the first transmission direction, and the third transmission direction intersects the first transmission direction with a first nonzero angle and intersects the second transmission direction with a second nonzero angle.

10. The touch panel as claimed in claim 9, wherein the first IR transmitters and the first IR receivers are mounted along two opposite edges of a touch panel respectively, and the second IR transmitters and the second IR receivers are mounted along another two opposite edges of the touch panel.

11. The touch panel as claimed in claim 10, wherein any of multiple touch points over the touch panel is sensible by checking whether one of the first IR receivers has no signal reception along the first transmission direction and simultaneously two of the second IR receivers have no signal receptions along the second transmission direction and the third transmission direction.

12. The touch panel as claimed in claim 9, wherein the first nonzero angle and the second nonzero angle are 45 degrees.
